(19) United States
(12) Patent Application Publication
(10) Pub. No.: US 2003/0076695 A1
(43) Pub. Date: Apr. 24, 2003

(54) Area efficient method of detecting when a switch-mode power supply is within regulation

(76) Inventors: David Alexander Grant, Dallas, TX (US); Thomas Lane Fowler, Garland, TX (US)

Correspondence Address: Dan Swayze, Texas Instruments Incorporated, M/S 3999, P.O. Box 655474, Dallas, TX, 75265, US

(21) Appl. No.: 09/934,097

(22) Filed: Aug. 21, 2001

(51) Int. Cl. H02M 3/335

(52) U.S. Cl. 363/17

(57) ABSTRACT

A switch mode power supply (30) having a power-good function (34) which senses whether a switch mode converter (32) is switching. The power-good function determines and indicates that the switch mode power supply is within tolerance when the switch mode converter is switching, i.e., a duty cycle is between 0 and 100%. Conversely, has a duty cycle determined to be 0% or 100%, the power-good function determines and indicates that the power supply is outside tolerance. The power-good function circuitry senses the output directly, (mode A) wherein the switching converter is driven by an integrator consisting of an error amplifier within the feedback loop. The power-good function is simple, accurate, and saves valuable silicon space, especially when implemented in switch mode power supplies that are programmable and have multiple output lines.

### CROSS REFERENCE TO RELATED APPLICATIONS

Cross-reference is made to commonly assigned U.S. patent application Attorney's Docket Number TI-33249, filed herewith, the teachings of which are incorporated herein by reference.

### FIELD OF THE INVENTION

The present invention is generally related to the field of switch mode power supplies, and more particularly to the detection of when a switch mode power supply is within regulation, sometimes known as a “power-good” function.

### BACKGROUND OF THE INVENTION

Switch mode power supplies typically include a switching converter having a varying duty cycle. Conventionally, the switching converter is responsively driven by an integrator, such as an error amplifier configured in a feedback loop. To achieve regulation, the integrator typically increases or decreases the duty cycle of the switching converter until the power supply is within regulation, that is, having an output voltage, such as a dc voltage, within tolerance of a specification.

Conventional switch mode power supplies also typically have a “power-good” function. A “power-good indication” is typically an indication of whether the power supply is operating within intolerance. Conventional methods of providing this “power-good” function require excessive amount of circuitry, especially since these types of power supplies typically have multiple outputs which can be programmed to multiple output voltages, thus necessitating a separate “power-good indication” for each of the multiple outputs. In addition, the presence of multiple out requires that each circuit be very accurate to reduce the probability of yield loss at test.

FIG. 1 illustrates one conventional approach at 10 providing a power good indication. This approach is seen to include a fixed reference voltage provided to a pair of comparators, each comparator tapping off a high precision resistive divide network configured to sense the output of the switch mode converter. This approach is typically referred to as a “window comparator”, as it includes circuitry determining whether the output voltage of the switch mode converter is within a “window” determined to be acceptable and within tolerance. The inherent disadvantages of this approach is the need for an accurate resistive divide network, requiring precision resistors. The need for comparators and resistors, including high accuracy resistors, takes up valuable real estate in the silicon, necessitating complex circuitry to achieve accuracy.

Another conventional approach is shown at 20 in FIG. 2, whereby the window comparator, includes a PWM comparator and additional pairs of comparators for each output power line. Again, the additional need of comparators takes up valuable silicon space, is complex, and is subject to accuracy problems.

There is desired an improved switch mode power supply having an improved “power-good” function that reduces the amount of circuitry required, especially for power supplies having multiple programmable output lines.

### SUMMARY OF THE INVENTION

The present invention achieves technical advantages as a switch mode power supply having a “power-good” function that determines whether or not the switching converter is switching to determine if the power supply is within regulation. It is recognized by the present invention that a switch mode power supply has a switch mode converter operating somewhere between a zero and 100% duty cycle if it is within regulation. Thus, the present invention takes advantage of this operation by detecting whether or not the duty cycle is 0% or 100% which indicates whether the control loop is keeping the power supply in regulation. Advantageously, the present invention uses an existing accurate error amplifier to determine whether or not the switching converter is switching. A binary or digital output is provided which indicates whether or not the power supply is within regulation. The power good function of the present invention conserves valuable silicon die space due to its inherent simple design, and is highly accurate. There is no need for accurate high precision resistive divide networks, or additional amplifiers.

### BRIEF DESCRIPTION OF THE DRAWINGS

For a more complete understanding of the present invention, reference is made to the following detailed description taken in conjunction with the accompanying drawings wherein:

FIG. 1 is a prior art window comparator circuit sensing a switch mode converter using a resistive divide network including high precision resistors and a plurality of additional comparators;

FIG. 2 is also a prior art approach depicting a window comparator including a PWM comparator and additional comparators to provide a power good function;

FIG. 3 is a schematic of the present invention including a switch mode converter and a power good function sensing the switching of the switch mode converter;

FIG. 4 is a waveform diagram depicting pulsed signal at mode B when the comparator is switching;

FIG. 5 is a waveform diagram depicting when the comparator is high all the time such that signal line B is always high;

FIG. 6 is a waveform diagram depicting when the comparator is low all the time such that signal line B is also being high all the time;

FIG. 7 is a waveform diagram depicting when the switching comparator is not switching and then when the switching comparator is switching such that the output line F is indicative of whether or not the comparator is switching;

FIG. 8 is a functional block diagram of a switching power supply incorporating the power good function of the present invention;

FIG. 9 is a serial control interface timing diagram of the power supply of FIG. 8;

FIG. 10 is an eight channel application circuit schematic including two power supplies coupled to a common serial control interface; and

FIG. 11 is a block diagram of an eight channel AC5 line cord; implementing the power supply.

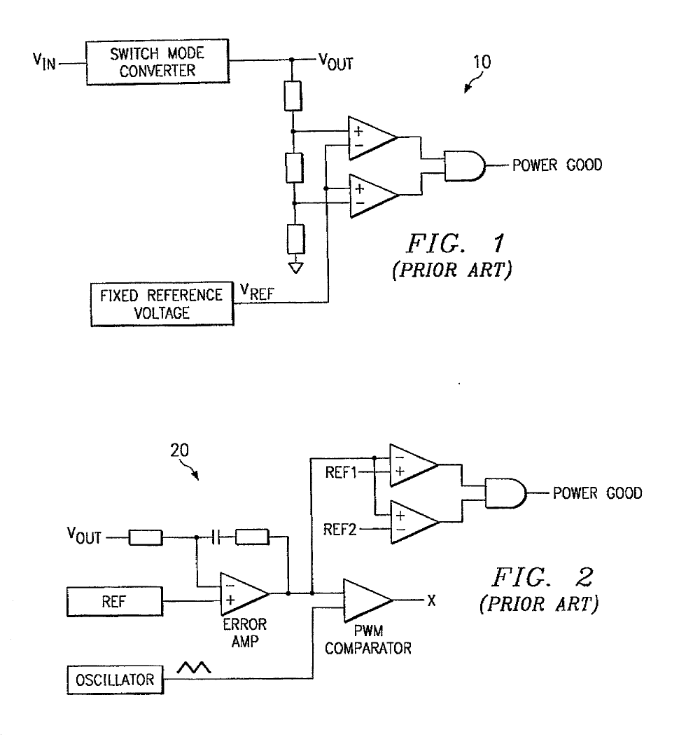

### DETAILED DESCRIPTION OF THE PREFERRED EMBODIMENT

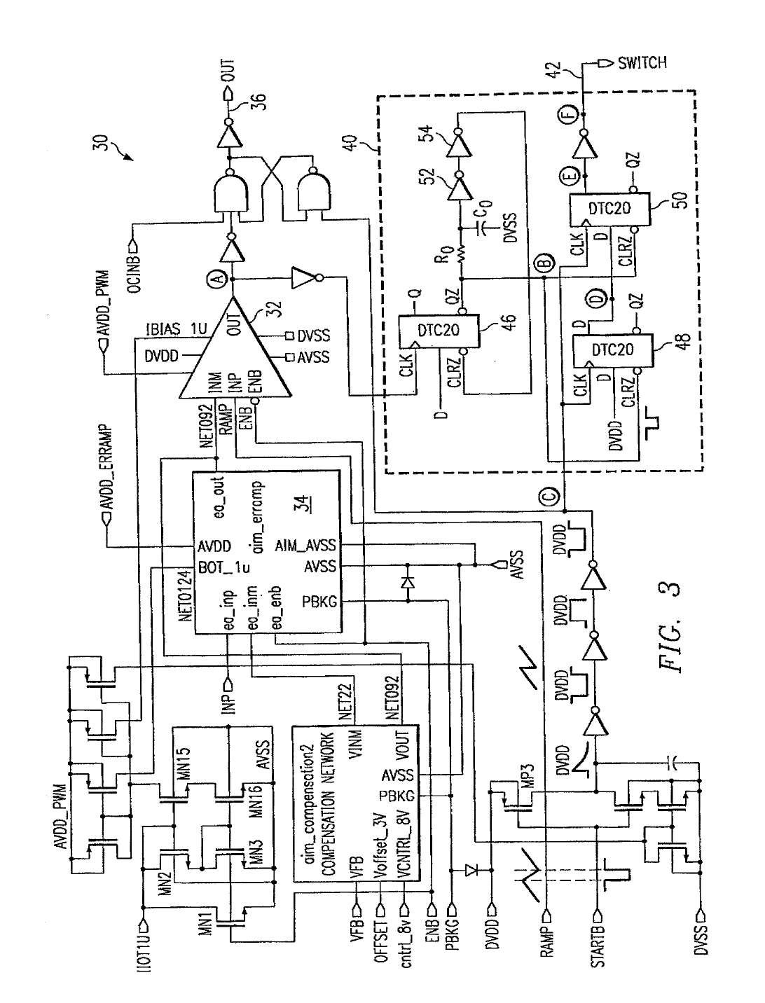

Referring now to FIG. 3, there is depicted generally at 30 a switch mode converter circuit including an integrator 32 and an error amplifier 34 in a feedback loop. If the output 36 of the converter circuit 30 is not held in regulation, the integrator 32 will eventually cause the duty cycle of the converter circuit 30 to reach either 100% or 0%.

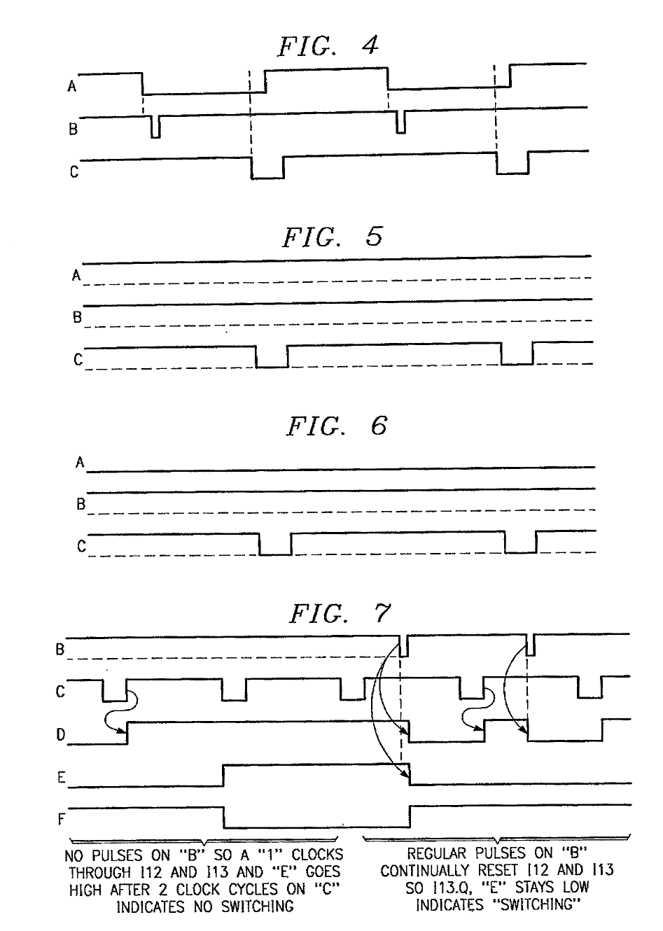

The present invention includes a simple, small, digital circuit 40 used to detect when the duty cycle of the converter circuit is at either 100% or 0%. If the duty cycle is determined by circuit 40 to be at 0% or 100%, the circuit 40 indicates an output 42 reports that the converter 30 is not regulating within tolerance. Circuit 40 is seen to include D-type latches 46, 48 and 50, as well as inverters 52 and 54, as well as resistor R0 and capacitor C0. When the switching converter circuit 30 is running at a duty cycle other than 0% or 100%, there is a continual stream of pulses provided from node A to the clock input of latch 46. Latch 46, resistor R0, capacitor C0 and inverters 52 and 54 are configured to form a one-shot timer. As long as the converter 30 does not have a 0% or 100% duty cycle, there is a stream of regular negative going pulses at the QZ output of the latch 46, as depicted in FIG. 4.

The continual stream of pulses from latch 46 resets the shift registers 48 and 50, so that the “switch” output signal shown at 42, depicted as waveform F, remains high and which is indicative that the converter 30 is within tolerance.

If the stream of reset pulses stops at node B, as depicted in FIG. 5 and FIG. 6, a logic “1” is clocked through registers 48 and 50 and the switch output signal 42 goes low, indicating that the converter circuit 30 has stopped switching and thus the converter 30 is at either 0% or 100% duty cycle, which indicates that the converter 30 is not in regulation.

FIG. 5 depicts when the comparator 32 is high all the time, and the series of pulses at node B stop. FIG. 6 indicates when the comparator 32 has an output that is low all the time, also causing the output signal line B to remain high all the time.

As depicted in the left half of FIG. 7, when no pulses are provided at node B, a logic “1” clocks through registers 48 and 50, and the signal at node E goes logic high after 2 clock cycles at node C, indicating that the converter 30 is not switching.

The right side of the diagram in FIG. 7 illustrates that when a regular series of pulses are provided at node B, these pulses continually reset registers 48 ad 50 so that node E stays low, causing node F to go high and correspondingly indicating that the converter is switching.

The present invention achieves technical advantages by providing a binary output signal on signal output line 42 indicative of whether or not the switching converter 36 is switching. The present invention assumes that while the switching converter 32 is switching, the power supply is within regulation. Conversely, when the converter stops switching 32, it is determined that the power supply is not within regulation. This corresponding output signal is provided as a logic high on output line 42 when the converter 33 switching, and providing a logic low on output line 42 when the converter is not switching.

The present invention achieves technical advantages by using an existing accurate error amplifier 34 to directly detect whether or not the control loop is within regulation. No additional precision resistors or comparators are required, thus realizing a savings in silicon space. The present invention is highly accurate and applicable to converters for all output voltages being provided.

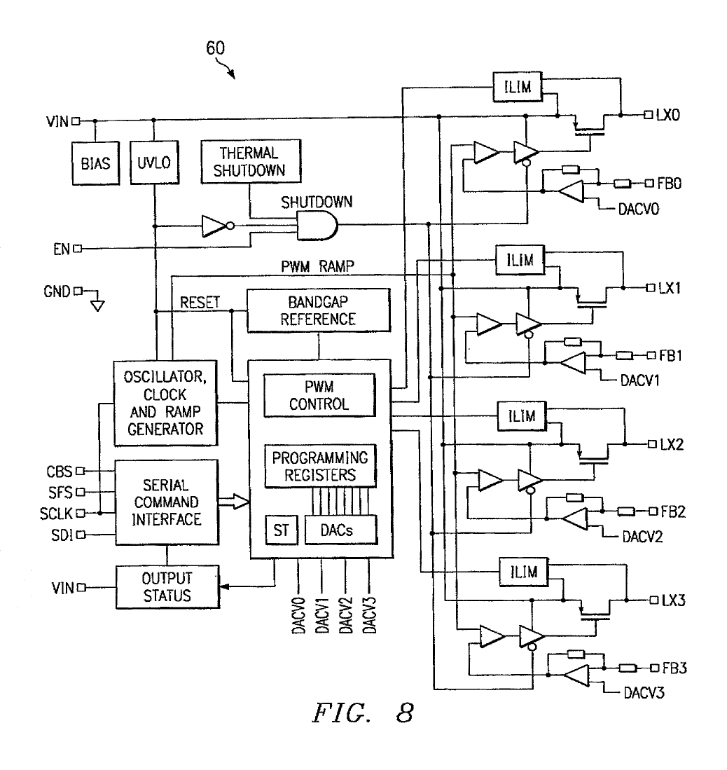

Referring now to FIG. 8, there is shown at 60 a four channel, voltage mode step-down converter incorporating the present invention, providing four independently controllable output voltages. Each regulated channel includes a high-side PMOSFET switch with a typical R_{Ds} (ON) of one ohm, which makes it suitable for high efficiency, low current applications. Commands sent to the converter 60 over the four wire serial port program the outputs independently or globally to supply voltages from 7.5 Volts to 13.1 Volts in 0.4V increments. When the input voltage is desired at an output, a bypass mode can be activated which fully enhances the PMOSFET switch and disables the switching circuitry of the selected channel.

The converter 60 is an ideal companion device to power Texas Instruments THS7102 ADSL line drivers as a part of the AC5 Central Office ADSL chipset. With the AC5 chipset controlling the converter 60 output voltages, significant power savings are realized by reducing the excess supply headroom on a per line basis.

Pin Assignments

Pin assignments of a 16 pin package are defined in Table 1 below.

TABLE 1

| PIN | | | |
|---|---|---|---|
| NAME | NO. | PIN DESCRIPTION | FUNCTIONAL DESCRIPTION |
| LX0 | 1 | Channel 0 switch output | Output to inductor and catch diode |
| LX1 | 2 | Channel 1 switch output | |
| GND | 3 | Ground | Power and Analog Ground |
| SFS | 4 | Frame sync input | Read/Write frame start strobe |
| SDI | 5 | Serial data in | 8 bit address/16-bit data word signal |
| EN | 6 | Enable | EN < Vᵢₗ: Disable all channels, |
| | | | EN > Vᵢₗ: Enable activates |
| | | | outputs (see text) |
| FB0 | 7 | Channel 0 feedback input | Feedback from L-C filter output |
| FB1 | 8 | Channel 1 feedback input | |
| FB2 | 9 | Channel 2 feedback input | |
| FB3 | 10 | Channel 3 feedback input | |
| CBS | 11 | Channel bank select | Assigns internal channels to |
| | | | respond to serial |
| | | address bit ADR2= 0 when | |
| | | | CBS <Vᵢₗ, or to |
| | | | ADR2 = 1 when CBS > Vᵢₕ |
| SCLK | 12 | Serial clock input | Serial clock/ |
| | | | synchronization signal |
| SDO | 13 | Serial data out | Status data output signal |
| VIN | 14 | Input supply voltage | Chip supply |
| | | | and channel 0-3 switch input |
| LX2 | 15 | Channel 2 switch output | Output to inductor and catch diode |
| LX3 | 16 | Channel 3 switch output | |

With continued reference to FIG. 8, various functional blocks will now be discussed.

Reference System/Voltage Divider & Multiplexer

The reference system consists of a band-gap circuit, four digital to analog converter outputs (DACs), and smoothing filters. The reference system provides independent set-point voltages to the PWM control loops of each channel, and are programmed via the 4 wire serial port. Output control of the regulators is provided in 15 steps with 400-millivolt resolution over a range of 7.5V to 13.1V. The DACs can also be programmed to force the PMOSFETs into the fully “on” pass-through or bypass mode to pass the input voltage to any output.

UVLO Circuit & Power-Up State

The Under-Voltage Lockout (UVLO) circuit controls device operation when the input voltage is below the UVLO threshold such as during power-up or power-down. Hysteresis built in to the UVLO detection circuit reduces sensitivity to noise and ripple on the power supply inputs to the converter 30. Prior to reaching the UVLO threshold, the ramp oscillator is disabled so that no switching occurs in the converter 10, the PMOS transistors are forced into the off state, and the registers and DACs are reset. Once the UVLO threshold is reached, the soft-start sequence begins. If the input voltage falls below the UVLO threshold after the device is programmed and operating, all four outputs are disabled, the DACs are set to zero volts and the programming registers are reset. Subsequently returning VIN above the UVLO threshold will require re-initialization of the phase stagger and channel voltage programming.

Soft-Start Sequence and Voltage Transitioning

When the supply voltage exceeds the UVLO threshold, the converter 30 is ready to be programmed via the serial interface. As each channel is programmed and enabled with a voltage code, the channel DACs begin stepping the output up from zero volts to the target voltage in 200-millivolt increments. If the target voltage is 15 Volts (i.e.pass-through mode) the DAC will continue to increment in 200-millivolt steps between 13.1 Volts and the fully “on” state. When a channel is commanded to transition from one voltage level to another, the output steps up (or down) to the new level in 200-millivolt increments. The period between each DAC increment is approximately 250 microseconds when the SCLK frequency equals 4.416 MHz. This results in a maximum ramp-up time of 8 milliseconds when stepping from OV to 15V, and a maximum transition time between max and min regulation voltages (7.5V, 13.1V) of 4 milliseconds. The use of small stop increments provides a smooth predictable ramp and prevents inadvertent tripping of the overcurrent limit.

Note that while an output is transitioning to the new target voltage, its voltage code register is protected from being overwritten. During this transition period, the channel status may be read via the 4 wire serial port using the read protocol. The data returned will be non-zero while channel is transitioning.

Oscillator, Divider & Sync Circuit

The converter 30 has a free-running internal ramp oscillator that operates at a nominal frequency of 450 kHz. When the 4.416 MHz SCLK signal is present, a synchronous divide-by-eight circuit provides a 552 kHz clock to synchronize the PWM ramp. The start of the ramp is coincident with every eighth rising edge of SCLK. If the converter 30 SCLK pin is driven at a frequency lower than eight times the free-running frequency of the oscillator (f_{osc}), it may result in chaotic operation. Care should be taken to guarantee that the minimum frequency at the SCLK input is 4.0 Megahertz.

Phase Stagger Circuit

When two converter circuits 30 are used as a pair to operate as an 8-channel unit, the PWM ramps in the two devices can be advantageously phase staggered to reduce input ripple and bypass requirements as previously discussed in detail earlier. The initialization command forces the PWM ramp of the converter 30 with its CBS pin tied low to be staggered by four SCLK cycles compared to the device with its CBS pin forced to a logic high. Note that this command clears the voltage programming in both converters 30 and disables the outputs. Voltage programming instructions can be issued immediately following the initialization command.

Enable (EN)

If the EN pin is held low when the converter 30 is powered up, the oscillator will start and free-run. Serial commands to initialize the PWM clocks and program the output levels will be accepted, but the outputs will be held off and will not begin regulating until the EN pin is pulled above Vᵢₕ.

If the converter 30 is programmed with outputs enabled when EN is pulled LOW, all outputs are shut off and all DACs are reset. The EN pin does not affect the oscillator, which continues to run and maintain PWM phase stagger. The previously programmed channel voltages are also maintained in the registers. If EN is pulled above Vᵢₕ, the converter 30 channels start up through the soft-start sequence and reach regulation at the previously programmed target voltages.

Bypass mode may be forced on all outputs by pulling EN above VIN—0.2V. When bypass mode is forced, all four channels step up to 15V in 200-millivolt increments.

Over Current Protection

During steady state operation, the overcurrent protection threshold is 150 milliamps minimum, 300 milliamps maximum, sampled approximately 500 nanoseconds after the start of the switching cycle. When overcurrent is sensed in the PMOSFET, the output is disabled for a “hiccup” time of 170 to 360 milliseconds (SCLK=4.416 MHz). In the “pass-through” mode, the overcurrent detection remains active and the “hiccup” behavior is unchanged.

During the soft-start sequence and voltage transitioning, the currents in the PMOSFET are higher than steady state. The overcurrent trip threshold is increased to prevent inadvertent shut-down & re-start action (hiccupping) in the overcurrent protection circuit.

Thermal Shutdown

Thermal shutdown disables the controller if the junction temperature exceeds 150° C. The hysteresis is 10° C. This shuts down off the switching circuitry and resets the soft-start circuitry. If the IC returns to normal temperature, it re-starts and returns to the programmed target voltages.

Serial Control Interface Timing Diagram

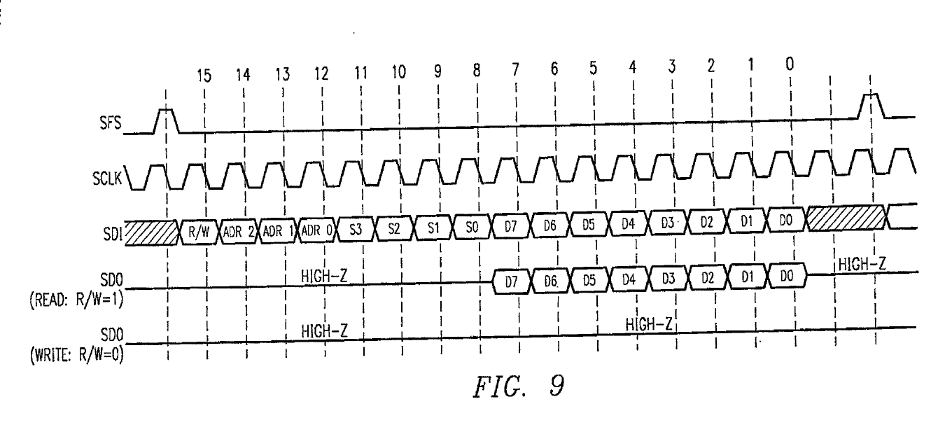

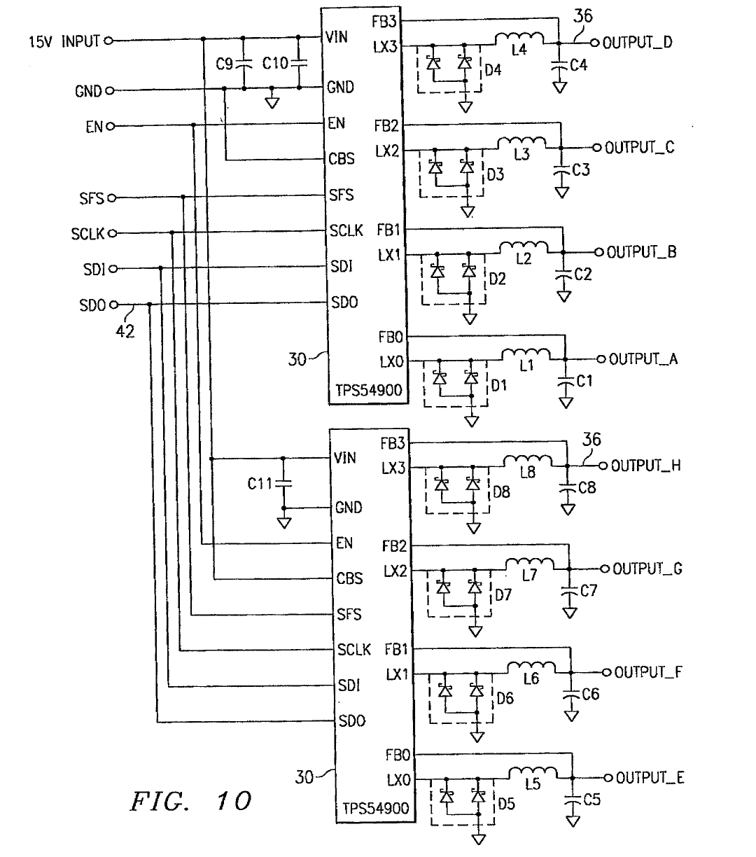

The serial control interface timing is depicted in FIG. 9.

Serial Command Bit Assignments

The serial command bit assignments are depicted in Table 2 below.

TABLE 2
SERIAL BIT

| POSITION | NAME | DESCRIPTION |
|---|---|---|
| 15 | R/W* | Set to logic 1 to read from converter, set to logic 0 to write to |
| | | converter |
| 14 | ADR2 | Channel bank select, compared to logic state of CBS pin to |
| | | select between two converter devices used in an 8 channel |
| | | configuration |
| 13 | ADR1 | Internal channel select MSB, used with ADRO to select one |
| | | of four output channels |
| 12 | ADRO | Internal channel select LSB, used with ADRi to select one |
| | | of four output channels |
| 11 | S3 | Device address MSB (S3=1 required to address converter) |
| 10 | S2 | Device address bit S2=1 required to address converter) |
| 9 | S1 | Device address bit (S1=1 required to address converter) |
| 8 | S0 | Device address LSB (SO=1 required to address converter) |
| 7 | D7 | Voltage programming MSB |
| 6 | D6 | Voltage programming bit |
| 5 | D5 | Voltage programming bit |
| 4 | D4 | Voltage programming LSB |
| 3 | D3 | Channel enable/disable (D3=0 enables channel(s)) |
| 2 | D2 | Global start |
| 1 | D1 | Unassigned |
| 0 | DO | Initialize counters |

Valid Commands

Valid commands to the converter are shown in Table 3 below.

TABLE 3

| WORD | DESCRIPTION |
|---|---|
| 0000111100001001 | Initialize PWM clocks with phase stagger and disable all |
| | channels |
| Oddd1111vvvv0100 | Turn on & regulate all channels to voltage code vvvv (see |
| | voltage programming code table) |
| Oaaa1111vvv0000 | Turn on & regulate channel aaa to voltage code vvvv (see |
| | voltage programming code table) |
| Oaaa111dddd1000 | Disable channel aaa |
| 1aaa1111dddddddd | Read channel status from channel aaa |

Voltage Programming Codes

Voltage programming codes are shown by Table 4 below.

TABLE 4

| VOLTAGE CODE | OUTPUT | VOLTAGE CODE | OUTPUT |
|---|---|---|---|
| (D4-D7) | VOLTAGE | (D4-D7) | VOLTAGE |
| 0 | 7.5 | 8 | 10.7 |
| 1 | 7.9 | 9 | 11.1 |
| 2 | 8.3 | A | 11.5 |
| 3 | 8.7 | B | 11.9 |
| 4 | 9.1 | C | 12.3 |
| 5 | 9.5 | D | 12.7 |
| 6 | 9.9 | E | 13.1 |
| 7 | 10.3 | F | Pass through |
| | | | mode |

Channel Status Read Back Codes

Channel status read back codes are shown in Table 5 below.

TABLE 5

| STATUS BYTE VALUE | OUTPUT |
|---|---|
| (D0-D7) | MEANING |
| 00h | Channel settled to regulation window |
| FFh | Channel not settled or fault condition (note 1) |

Note 1: Fault conditions detected include over current fault on channel addressed and over temperature fault for device (all channels)

Serial Interface Protocol

The serial interface uses SCLK (Serial Clock), SFS (Serial Frame Sync), SDI (Serial Data In) and Bank Select inputs, and outputs device status on SDO (Serial Data Out). SFS and SDI inputs are sampled on the falling edge of SCLK. An SFS pulse indicates that the bus master is ready to transmit a word, and the bit and frame counters in the converter 30 are reset when SFS is high. The first bit (b15) of the 16-bit word is shifted in on the next failing edge of SCLK. The first eight bits of the word are denoted as the Address or Command, and the last eight bits are Data. Refer to the table titled “Serial Command Bit Assignments”.

The Command consists of three fields—the R/W bit; Channel Select bits ADR2-0; and four Device Select bits S3-SO. The R/W bit determines whether the data portion of the word will be written to the converter 30 or read from the converter 30. The value in the Channel Select field determines which output channel is to receive programming data. Channel select bit ADR2 is compared to the logic level on the Channel Bank Select input. This allows two distinct converter 30 devices to be addressed as one logical eight-channel unit. The remaining bits ADR1, ADR0 are decoded to select one of the four on chip channels. The third part of the command is the 4-bit Device Select, bits S3-SO. The converter 30 has been assigned a device ID of “F” for S3-S0. This value must be used to address converter devices.

The data field, D7-D0, is used to program output voltage levels and control converter 10 operation.

Pass Through Mode

The pass through mode may be used to force a channel's PMOSFETs to remain in the fully enhanced “on” state. Use of the pass through mode is desirable under several conditions. First, transmitting high peak-to-peak voltages will require maximum headroom on the line driver supply. Second, if the load current is too small, the Line Ranger circuit will be required to operate in discontinuous mode. The output may ring in response to transient conditions. Low load current conditions may occur if the line driver is idle and the quiescent current has been reduced to conserve power. If the line must remain ready to return to normal operation, the pass through mode is appropriate. If the line is unused or can tolerate start up delays, the channel shut down mode should be considered to conserve additional power.

Channel Shut Down

A bit value of 1″ in bit 3 is used to shut down the addressed channel. Shutting down of an unused channel is recommended when power savings warrant complete power down of a line driver, and start up delays in returning to normal operation are not critical.

Global Program

Data Bit 2 in the serial word is the “global turn-on and regulate” signal. It is used to program all outputs to the same voltage and start them up at the same time.

PWM Clock Initialization

Data Bit 0 is used to initialize the on-board clocks. The signal to initialize the clocks is ANDed with data bit 5 and cannot be given without powering down the converter 36 and going through a complete restart sequence.

Status Readback

The converter 36 is designed to monitor its output state and recognize when it has settled into regulation at its programmed value according to the present invention as previously described in detail. The SDO pin, output 42, reports a channel in a voltage transition or error condition (Channel Not Ready) by returning a data value of FFh. When SDO returns a value of 00h, the channel is in regulation.

The following conditions will cause a “Channel Not Ready” status to be reported:

Channel Disabled

PWM duty factor outside expected range (i.e. 0% or 100% PW)

Channel in overcurrent

Channel Transitioning to New Target Value

Over-temperature Shutdown (affects all four channels)

Noise immunity circuits in the fault detector introduce a delay in the reporting of the channel status. For instance, if a command to transition to a new target voltage is issued, the output voltage may be stable up to 250 microseconds before the detection circuit reports that the channel is ready. The minimum recommended status polling interval per channel is 500 microseconds.

Recommended Component Values

Table 7 depicts recommended component values for use of converter 30.

TABLE 7

| Ref. | | | | | |
|---|---|---|---|---|---|
| Designator | Device | MFR #1 | P/N | MFR #2 | P/N |
| C1-5 | 10 uF Tantalum Cap | Kemet | T495D106 | | |
| | | | M035AS | | |
| C6 | 0.1 uF Ceramic Cap | Kemet | | AVX | |
| L1-4 | 220 uH Inductor | GCI | 5143 | JW Miller | PM74S- |
| | | | | | 221K |
| D1-4 | Schottky Diode | Diodes, Inc. | BAT54AW | | |

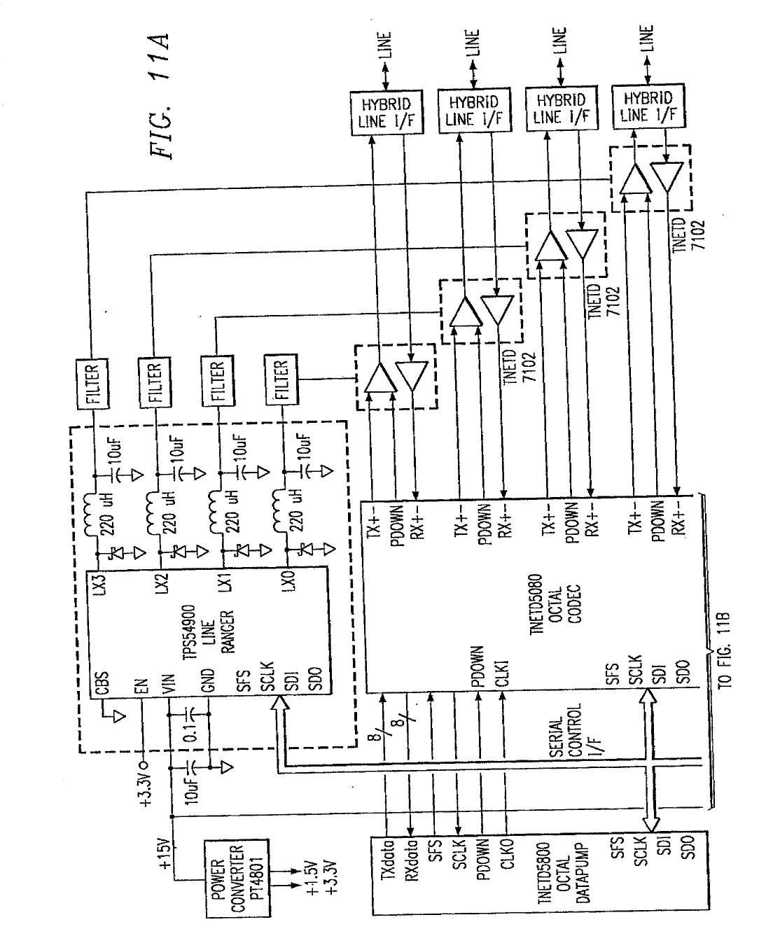

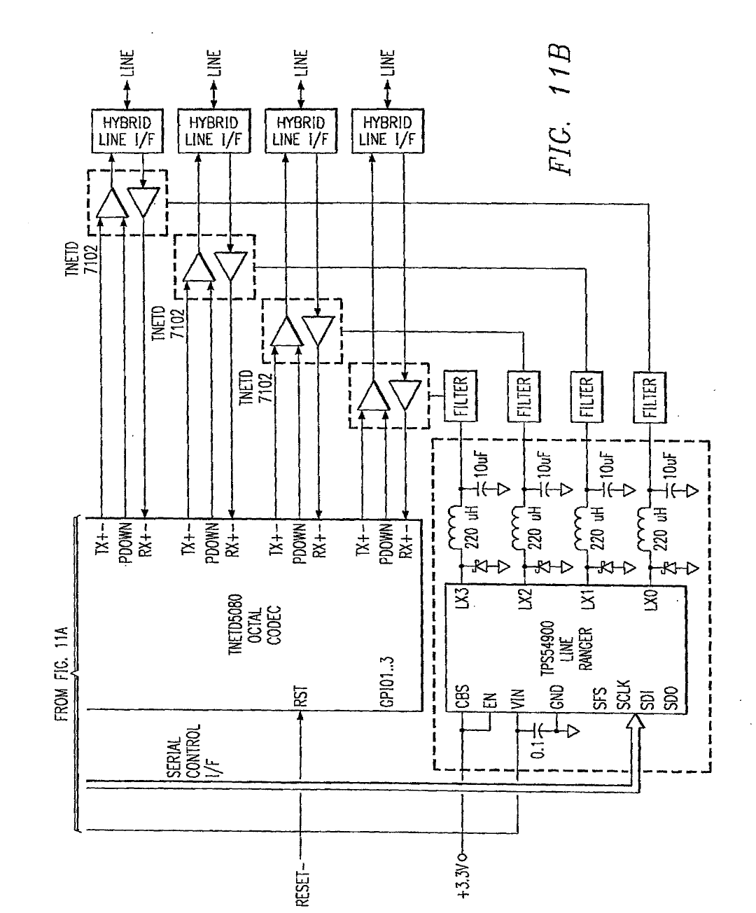

FIG. 11 depicts a block diagram of an eight channel AC5 line card with a Texas Instruments Line Ranger option and utilizing the power converter 30 of the present invention.

The numerous innovative teachings of the present application will be described with particular reference to the presently preferred exemplary embodiments. However, it should be understood that this class of embodiments provides only a few examples of the many advantageous uses and innovative teachings herein. In general, statements made in the specification of the present application do not necessarily delimit any of the various claimed inventions. Moreover, some statements may apply to some inventive features, but not to others.

Although a preferred embodiment of the apparatus and system of the present invention has been illustrated in the accompanied drawings and described in the foregoing Detailed Description, it is understood that the invention is not limited to the embodiments disclosed, but is capable of numerous rearrangements, modifications, and substitutions without departing from the spirit of the invention as set forth and defined by the following claims.

What is claimed is:

1. A switching power supply, comprising:
a switch mode circuit running at a varying duty cycle, the circuit including a switching converter; and
a regulation indicator circuit coupled to the switching converter and generating an output signal indicative of whether the power supply is within regulation by determining if the switching converter is switching.

2. The switching power supply as specified in claim 1 wherein the switch mode circuit includes an integrator in a feedback loop, the switching converter having a duty cycle being a function of the integrator.

3. The switching power supply as specified in claim 2 wherein the switching converter is responsively driven by the integrator.

4. The switching power supply as specified in claim 2 wherein the integrator drives the duty cycle of the switching converter towards 100% until regulation is achieved.

5. The switching power supply as specified in claim 4 wherein the regulation indicator circuit indicates non-regulation when the switching converter duty cycle is either 0% or 100%.

6. The switching power supply as specified in claim 1 wherein the regulation indicator circuit comprises a series of logic gates clocked by a clock signal corresponding to the duty cycle.

7. The switching power supply as specified in claim 6 wherein the clock signal has the same frequency as the duty cycle when the power supply is regulated.

8. The switching power supply as specified in claim 7 wherein the logic gates include a D-type flip-flop gate.

9. The switching power supply as specified in claim 1 wherein the output signal generated by the regulation indicator circuit is binary.

10. The switching power supply as specified in claim 1 wherein the output signal is a logic 1 when the power supply is within regulation.

11. A method of operating a switching power supply having a switching converter, comprising the steps of:
determining if the switching power supply is within regulation by determining if the switching converter is switching.

12. The method as specified in claim 11, further comprising the step of sensing a duty cycle of the switching converter to determine if the power supply is within regulation.

13. The method as specified in claim 12 further comprising the step of determining if the duty cycle of the switching converter is 0% or 100% to determine if the power supply is within regulation.

14. The method as specified in claim 11 wherein the power supply has an integrator in a feedback loop, wherein the integrator increases a duty cycle of the switching converter towards 100% until regulation is achieved.

15. The method as specified in claim 11 further comprising the step of sensing the switching converter using a logic circuit clocked by a clock signal corresponding to a duty cycle of the switching converter.

16. The method as specified in claim 15 wherein the clock signal has the same frequency as the switching converter duty cycle.

17. The method as specified in claim 11 further including the step of generating a binary output signal indicative of whether the power supply is within regulation.

18. The method as specified in claim 11 further including the step of directly sensing the output of the switching converter to determine if the power supply is within regulation.

19. The method as specified in claim 14 wherein the integrator comprises an error amplifier.

20. The method as specified in claim 15 further including the step of determining if the power supply is within regulation within 2 clock cycles.
